(19) United States
(12) Patent Application Publication
(10) Pub. No.: US 2008/0050956 A1
(43) Pub. Date: Feb. 28, 2008

(54) Tube holder

(76) Inventor: Chung-Min Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,976

(22) Filed: Aug. 24, 2006

(51) Int. Cl. H01R 33/05

(52) U.S. Cl. 439/227

(57) ABSTRACT

A tube holder includes a flat surface formed on a top thereof and a connecting seat formed on a bottom of the tube holder. The connecting seat is provided to electrically connect to a power source. A first tube connector and a second tube connector respectively extend from the flat surface of the tube holder. The first tube connector and the second tube connector are respectively provided to electrically receive two electrodes of a spiral tube.

### BACKGROUND OF THE INVENTION

1. Field of the Invention

The present invention relates to a tube holder, and more particularly to a tube holder that reduces thermal conduction and provides a function of heat dissipation.

2. Description of Related Art

A conventional tube holder (40) in accordance with the prior art shown in FIGS. 5 and 6 comprises a first tube connector (42) and a second tube connector (43) formed on a top portion thereof. A first slant surface (47A) extends from a lower side (420) of the first tube connector (42) to a top of the second tube connector (43) and a second slant surface (47B) extends from a lower side (430) of the second tube connector (43) to a top of the first tube connector (42). A spiral tube (30) has two electrodes respectively and electrically received in the first tube connector (42) and the second tube connector (43). However, only a gap (45) formed among the spiral tube (30), the first slant surface (47A) and the second slant surface (47B) such that the space is insufficient for heat dissipation. As a result, the tube holder (40) may be deformed or oxidized due to the heat from the spiral tube (30) after used for a long time.

The present invention has arisen to mitigate and/or obviate the disadvantages of the conventional tube holder.

### SUMMARY OF THE INVENTION

The main objective of the present invention is to provide an improved a tube holder that reduces thermal conduction and provides a function of heat dissipation.

To achieve the objective, the tube holder in accordance with the present invention comprises a flat surface formed on a top thereof and a connecting seat formed on a bottom of the tube holder. The connecting seat is provided to electrically connect to a power source. A first tube connector and a second tube connector respectively extend from the flat surface of the tube holder. The first tube connector and the second tube connector are respectively provided to electrically receive two electrodes of a spiral tube. The top of the tube holder is a flat surface such that the space between the spiral tube and the tube holder is increased for effectively providing a function of heat dissipation and reducing thermal conduction.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tube holder in accordance with the present invention;

FIG. 2 is a side plan view of a tube holder in accordance with the present invention;

FIG. 3 is a perspective view of a first embodiment of the tube holder in accordance with the present invention;

FIG. 4 is a perspective view of a second embodiment of the tube holder in accordance with the present invention;

FIG. 5 is a side plan view of a conventional tube holder in accordance with the prior art; and

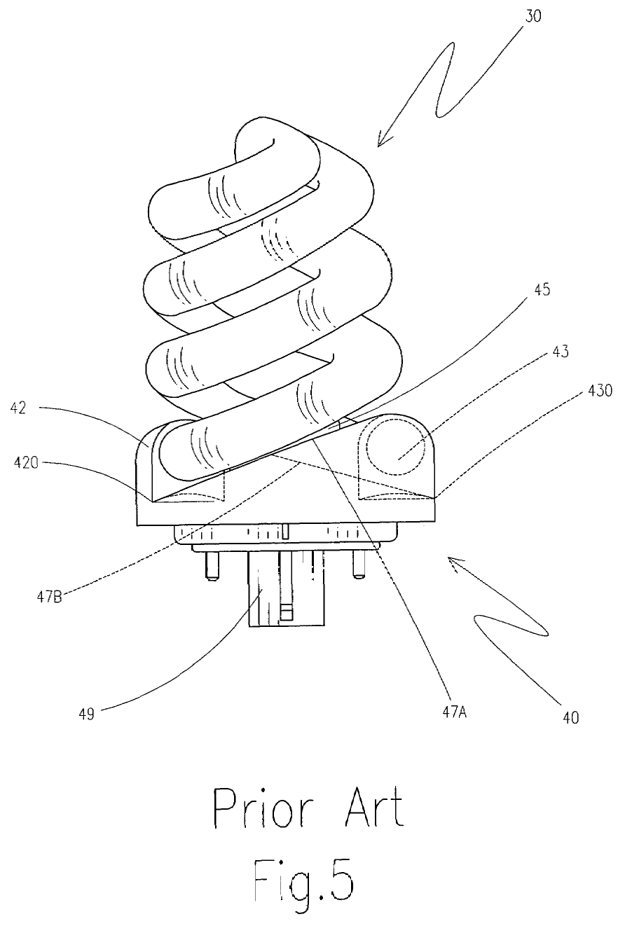

FIG. 6 is a perspective view of the conventional tube holder in accordance with the prior art.

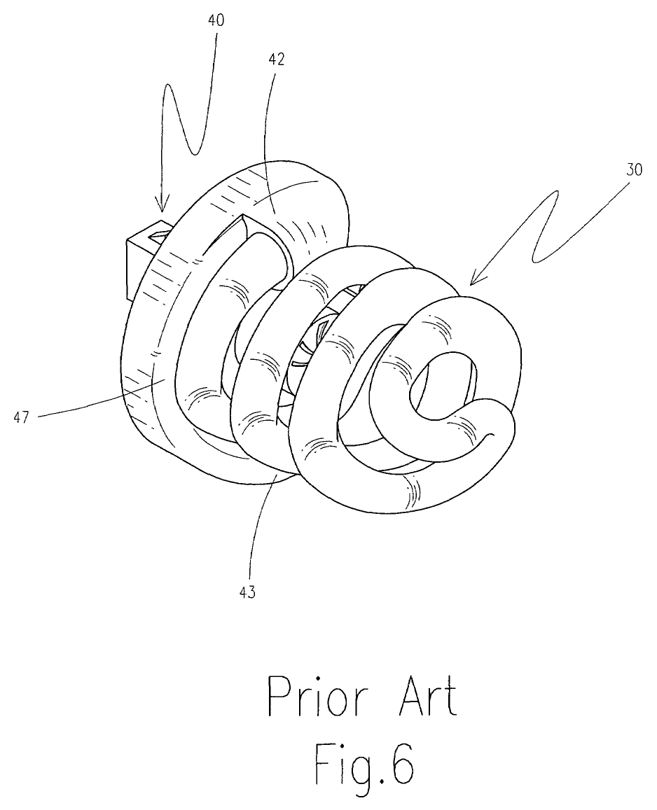

### DETAILED DESCRIPTION OF THE INVENTION

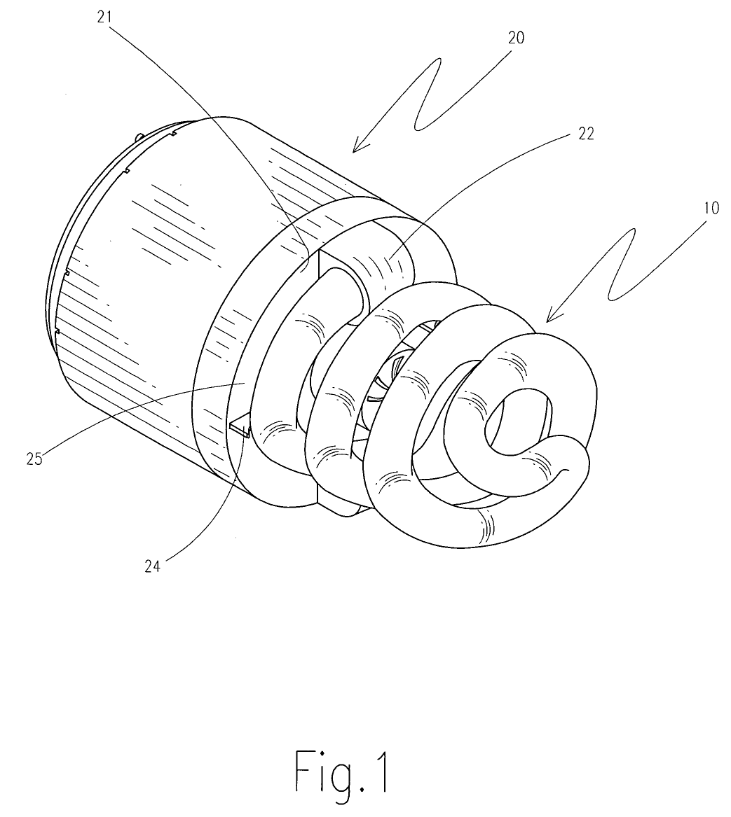

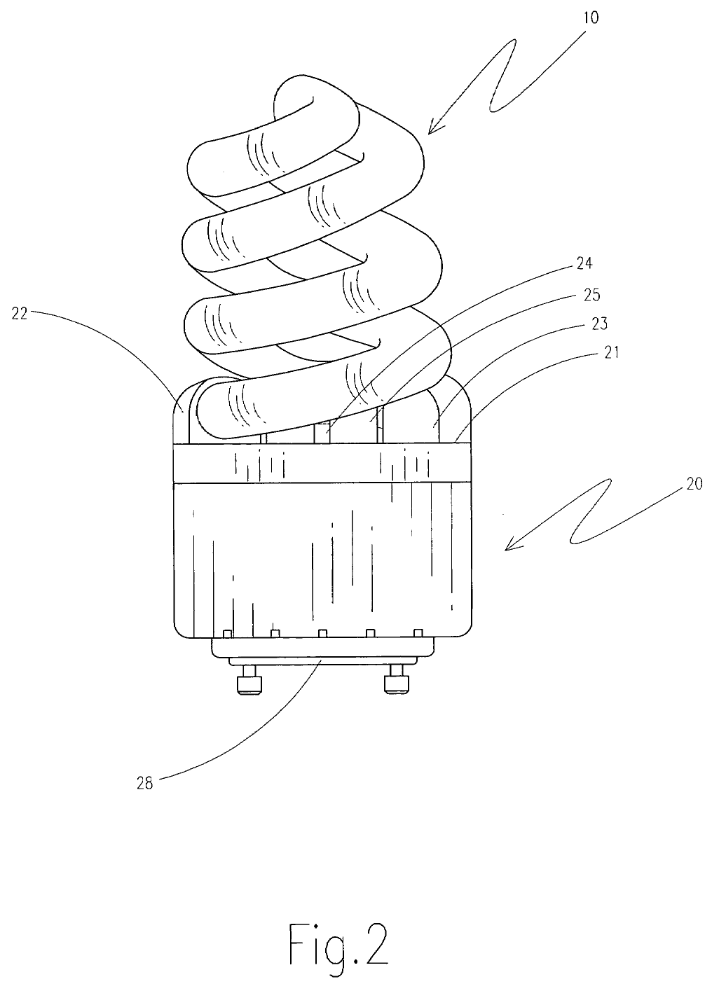

Referring to the drawings and initially to FIGS. 1 and 2, a tube holder (20) in accordance with the present invention is adapted to hold a spiral tube (10). The tube holder (20) has a flat surface (21) formed on a top thereof. A first tube connector (22), a second tube connector (23) and two supports (24) respectively extend from a periphery of the flat surface (21). A connecting seat (28) is formed on a bottom of the tube holder (20) and provided to electrically connect to a power source. The first tube connector (22) and the second tube connector (23) are adapted to electrically receive two electrodes of the spiral tube (10). The two supports (24) are adapted to support the spiral tube (10) when the spiral tube (10) electrically mounted to the tube holder (20) of the present invention.

The first tube connector (22) and the second tube connector (23) diametrically correspond to each other. The two supports (24) diametrically correspond to each other. The first tube connector (22), the second tube connector (23) and the two supports (24) equally divide a periphery of the flat surface (21) into four portions. The top of the tube holder (20) is a flat surface (21) such that the space between the spiral tube (10) and the tube holder (20) is increased for effectively providing a function of heat dissipation and reducing thermal conduction.

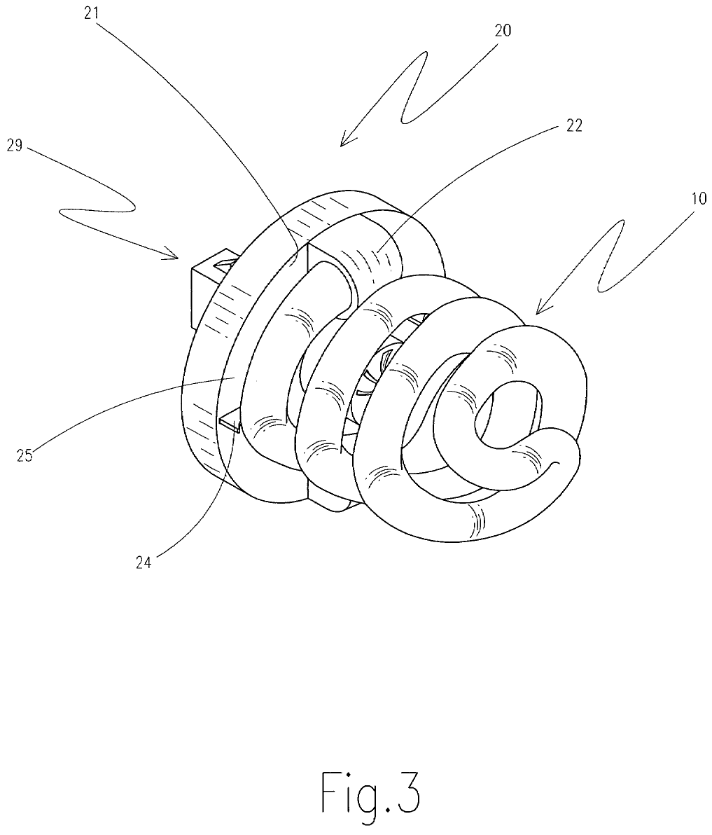

With reference to FIG. 3, the type of the connecting seat (28) is various. In the preferred embodiment of the present invention, the connecting seat (28) is a cubic block.

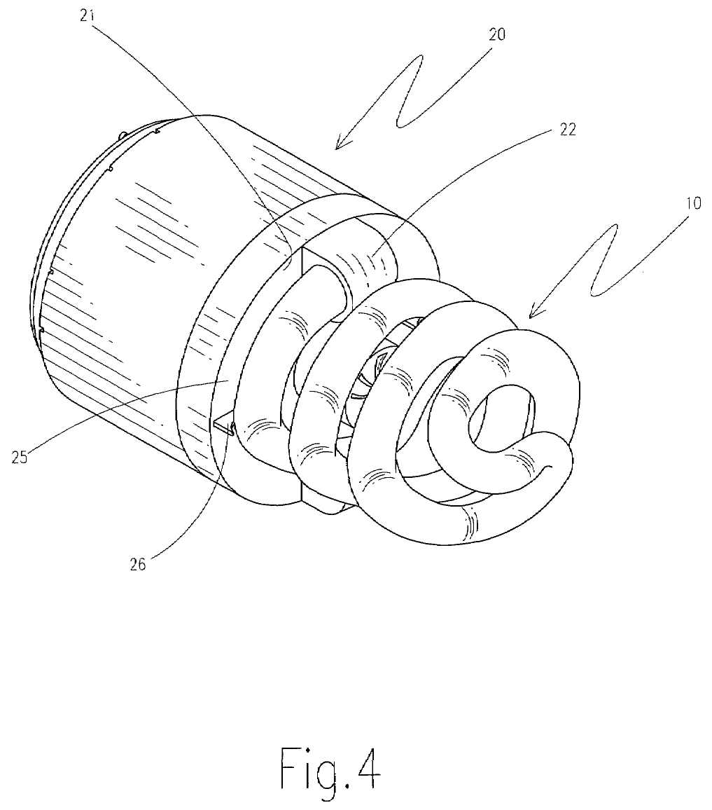

With reference to FIG. 4, the type of the two supports (24) is various. In the preferred embodiment of the present invention, each support (24) has a semicircle indentation defined in the top thereof for partially the spiral tube (10) and providing an effective support function.

Although the invention has been explained in relation to its preferred embodiment, it is to be understood that many other possible modifications and variations can be made without departing from the spirit and scope of the invention as hereinafter claimed.

1. A tube holder comprising a flat surface formed on a top thereof and a connecting seat formed on a bottom of the tube holder, the connecting seat adapted to electrically connected to a power source, a first tube connector and a second tube connector respectively extending from the flat surface of the tube holder, the first tube connector and the second tube connector respectively adapted to electrically receive two electrodes of a spiral tube.

2. The tube holder as claimed in claim 1, wherein the first tube connector and the second tube connector diametrically correspond to each other.

3. The tube holder as claimed in claim 1 further comprising two supports respectively extending from the flat surface of the tube holder, the two supports adapted to support the spiral tube when the spiral tube is electrically mounted on the tube holder.

4. The tube holder as claimed in claim 3, wherein the two supports diametrically correspond to each other.

5. The tube holder as claimed in claim 3, wherein each support has a semicircle indentation defined in the top thereof for partially the spiral tube and providing an effective support function.

6. The tube holder as claimed in claim 1, wherein the connecting seat is a cubic block.
